(19) United States
(12) Patent Application Publication
(10) Pub. No.: US 2009/0125998 A1
(43) Pub. Date: May 14, 2009

(54) SYSTEMS, METHODS AND DEVICES FOR SECURE REMOTE-ACCESS COMPUTING

(76) Inventor: Jordan Levy, Thornhill (CA)

Correspondence Address: HERMAN & MILLMAN, 141 ADELAIDE ST. WEST, SUITE 1002, TORONTO, ON, M5H 3L5, CA

(21) Appl. No.: 11/939,200

(22) Filed: Nov. 13, 2007

(51) Int. Cl. H04L 9/32; G06F 21/00

(52) U.S. Cl. 726/7; 726/3

(57) ABSTRACT

Previous attempts to provide systems or methods for remote-access computing typically involve the use of subscription-based third party platforms. The third party platforms serve as an intermediary between a home (or primary) computer and a local-host computer. There are a number of problems associated with these third party platforms that generally affect the security of information and possible performance expectations of users. By contrast, provided by aspects of the present invention there are systems, methods and devices for secure remote-access computing that enable more secure remote-access computing and may enhance predictability of performance from the perspective of the user.

### FIELD OF THE INVENTION

The invention relates to personal computing, and in particular to systems, methods and devices for secure remote-access computing.

### BACKGROUND OF THE INVENTION

Remote-access computing allows a user, operating a first computer, to access data and software on a second computer that may be remotely situated from the first computer. According to a specific prior art implementation, the first computer is a local-host and the second computer is a home (or primary) computer. The home computer includes data and software that belongs to the user and/or that the user is permitted to access and use. The local-host computer serves as a computing resource that the user may or may not have any ownership and/or administrative control of. For example, and without limitation, the local-host computer may be a laptop computer owned by the user, or the local-host computer may be a computer in a business center of a hotel, an internet cafe or a client site over which the user has no administrative control.

In accordance with previously available remote-access computing systems and methods, access to data and software on the home computer from the local-host computer is managed through a subscription-service provided by a third party. Typically, the third party provides a browser-based (e.g. an internet browser or the like) software application, provided from a separate server or the like, that manages data sharing between computers. A browser window on the local-host computer displays the desktop of the home computer so that the user can manipulate data and software located on the home computer through the browser window on the local-host computer. That is, the user remotely accesses data and software on the home computer through a browser window open on the local-host computer while the local-host computer otherwise operates normally.

There are a number of problems associated with the prior art remote-access computing systems and methods. First, because the local-host computer is running normally, processes and software applications specific to the local-host computer may contaminate the home computer with viruses, spyware or other malware. Second, because the systems are often browser-based, temporary files, passwords and/or other user-specific information are left on the local-host computers in caches or temp directories that support the browser. Moreover, the files on the home computer that the user accesses from the local-host computer are edited on the local-host computer, which allows them to be either intentionally or inadvertently stored on the local-host computer. If the user forgets to delete the files or does not know that the files are being stored on the local-host computer valuable information may be revealed or put in a position where the information could be revealed to those not entitled to view the information.

Third, the local-host computer may be configured to operate in a particular language (e.g. English, French, Chinese, etc.) that is foreign to the user. So while the user may be able to recognize the basic functionality of software applications by the configuration of toolbars and icons, the user may not be able to use more advanced functions to edit and manipulate data retrieved from the home computer. That is, the functionality available to the user may be limited as a result of language barriers that the user may not be able to avoid or know about in advance.

Fourth, because remote-access computing provided by the prior art involves a third party subscription service, the user is forced to entrust the management of data (which is possibly sensitive and/or valuable) to a third party. This presents problems for the third party and the user. The third party may be liable for losses of information transferred through the service or inappropriately and unwillngly disclosed as a result of the security of their server(s) being compromised. The user, regardless of the potential liability of the third party, may nevertheless lose valuable information or have the security of their information compromised.

Fifth, for the prior art systems and methods to work, the home computer must be on and running normally. This in itself causes security risks. In a remote-access computing scenario the user is not often near the home computer, which in turn leaves open the possibility that someone else may access the home computer or observe what the user is doing on the remote computer without being detected.

### SUMMARY OF THE INVENTION

According to an aspect of an embodiment of the invention, there is provided a device for establishing a connection between a first and second computer, the device comprising a connector suitable for connecting the device to the first computer; a flash memory chip for storing electronic data and computer program instructions; virtual platform software provided in a computer program product having computer program instructions for re-configuring, connecting and operating the first and second computers to operate jointly in order to provide secure remote-access computing; and a controller coupled between the controller and the and flash memory chip, the controller capable of executing computer program instructions.

In some embodiments, the connector is a Universal Serial Bus (USB) connector. In some other embodiments, the computer program product includes computer program code instructions for: pushing a message from the device to be displayed on the first computer, the message requesting a password to access the device; receiving a password from the user; and, verifying whether or not the pass word received from the user is correct, and if the password from the user is not correct denying the user access to the device, but if the password from the user is correct permitting the user to access the device.

In even other embodiments, the computer program product includes instructions for pushing the virtual platform software onto the local host from the device.

In some more specific embodiments, the virtual platform software includes computer program instructions for: disabling memory access to the local system memory on the first computer; establishing a network connection between the first and second computers by controlling a network port on the first computer; blanking the screen of the second computer; re-configuring the first and second computers to operate jointly using a network connection between them; overriding the display on the first computer to display the desktop of the second computer; and storing temporary files in the flash memory chip of the device instead of local system memory of the first computer.

In even more specific some embodiments the virtual platform software includes computer program instructions for providing the second computer with a computer program product for verifying user access to the second computer in some even more specific embodiments the computer program product for verifying user access to the second computer includes computer program instructions for: pushing a message from the second computer to be displayed on the first computer, the message requesting a password to access the second computer; receiving a password from the user; and verifying whether or not the password received from the user is correct, and if the password from the user is not correct denying the user access to the second computer, but if the password from the user is correct permitting the user to access the second computer.

In some embodiments, blanking the screen of the second computer includes one of controlling and disabling a video card within the second computer. In some embodiments overriding the screen of the first computer includes one of controlling a video card within the first computer. In some embodiments, re-configuring the first and second computers to operate jointly using a network connection between them includes controlling the operation of respective motherboards of the first and second computers.

According to some aspects of the invention, there is provided a method for establishing a connection between a first and second computer, the method comprising: pushing a message from a device to be displayed on the first computer, the message requesting a first password to access the device; receiving a password from the user; and verifying whether or not the password received from the user is correct, and if the password from the user is not correct denying the user access to the device, but if the password from the user is correct permitting the user to access the device.

According to some more specific aspects of the invention the method further comprising steps for: disabling memory access to the local system memory on the first computer; establishing a network connection between the first and second computers by controlling a network port on the first computer; blanking the screen of the second computer; re-configuring the first and second computers to operate jointly using a network connection between them; overriding the display on the first computer to display the desktop of the second computer; and storing temporary files in the flash memory chip of the device instead of local system memory of the first computer.

According to some more specific aspects of the invention the method further comprising steps for: pushing a message from the second computer to be displayed on the first computer, the message requesting a second password to access the second computer; receiving a password from the user; and verifying whether or not the password received from the user is correct, and if the password from the user is not correct denying the user access to the second computer, but if the password from the user is correct permitting the user to access the second computer.

According to some even more specific aspects of the invention, blanking the screen of the second computer includes one of controlling and disabling a video card within the second computer. According to some other even more specific aspects of the invention, overriding the screen of the first computer includes one of controlling a video card within the first computer. According to some even more specific aspects of the invention, re-configuring the first and second computers to operate jointly using a network connection between them includes controlling the operation of respective motherboards of the first and second computers.

According to some aspects of the invention there is provided a system for establishing a connection between a first and second computer, the system comprising a device having a connector suitable for connecting the device to the first computer, and a computer program instructions for re-configuring, connecting and operating the first and second computers to operate jointly in order to provide secure remote-access computing.

in some embodiments, the system includes a a flash memory chip for storing electronic data and computer program instructions; virtual platform software provided in a computer program product having computer program instructions for re-configuring, connecting and operating the first and second computers to operate jointly in order to provide secure remote-access computing; and a controller coupled between the controller and the and flash memory chip, the controller capable of executing computer program instructions.

Other aspects and features of the present invention will become apparent to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference wilt now be made, by way of example, to the accompanying drawings, which illustrate aspects of embodiments of the present invention and in which:

FIG. 1 is a simplified schematic illustration of a typical prior art system for remote-access computing;

FIG. 2 is a simplified schematic illustration of a motherboard (or mainboard) for a personal computer known in the art;

FIG. 3 is a simplified schematic illustration of a secure remote-access computing system provided in accordance with aspects of the invention;

FIG. 4 is a simplified schematic illustration of two motherboards re-configured to operate jointly in accordance with aspects of the invention;

FIG. 5 is a flow chart illustrating general method steps for initiating a secure remote-access computing session in accordance with aspects of the invention; and

FIG. 6 is a flow chart illustrating general method steps for re-configuring, connecting and operating two motherboards to operate jointly in order to provide secure remote-access computing in accordance with aspects of the invention.

### DETAILED DESCRIPTION OF THE INVENTION

Previous attempts to provide systems or methods for remote-access computing typically involve the use of subscription-based third party platforms. The third party platforms serve as an intermediary between a home (or primary) computer and a local-host computer. There are a number of problems associated with these third party platforms that generally affect the security of information and possible performance expectations of users. By contrast, provided by aspects of the present invention there are systems, methods and devices for secure remote-access computing that enable more secure remote-access computing and may enhance predictability of performance from the perspective of the user.

Aspects of the invention may be embodied in a number of forms, For example, various aspects of the invention can be embodied in a suitable combination of hardware, software and firmware. In particular, some embodiments include, without limitation, entirely hardware, entirely software, entirely firmware or some suitable combination of hardware, software and firmware. In a particular embodiment, the invention is implemented in a combination of hardware and firmware, which includes, but is not limited to firmware, resident software, microcode and the like that is included on a Universal Serial Bus (USB) flash drive (i.e. a USB key).

Additionally and/or alternatively, aspects of the invention can be embodied in the form of a computer program product that is accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device.

A computer-readable medium can be an electronic, magnetic, optical, electromagnetic, infrared, or semiconductor system (or apparatus or device) or a propagation medium. Examples of a computer-readable medium include a semiconductor and/or solid-state memory, magnetic tape, a removable computer diskette, a random access memory (RAM), a read-only memory (ROM), a rigid magnetic disk and an optical disk. Current examples of optical disks include, without limitation, compact disk read only memory (CD-ROM), compact disk-read/write (CD-R/W) and DVD.

In accordance with aspects of the invention, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Additionally and/or alternatively, in accordance with aspects of the invention, a data processing system suitable for storing and/or executing program code will include at least one processor integrated with memory elements through a system bus.

Input/output (i.e. I/O devices)—including but not limited to keyboards, touch-pads, displays, pointing devices, etc.—can be coupled to the system either directly or through intervening I/O controllers.

Network adapters may also be coupled to the system to enable communication between multiple data processing systems, remote printers, or storage devices through intervening private or public networks. Modems, cable modems and Ethernet cards are just a few of the currently available types of network adapters.

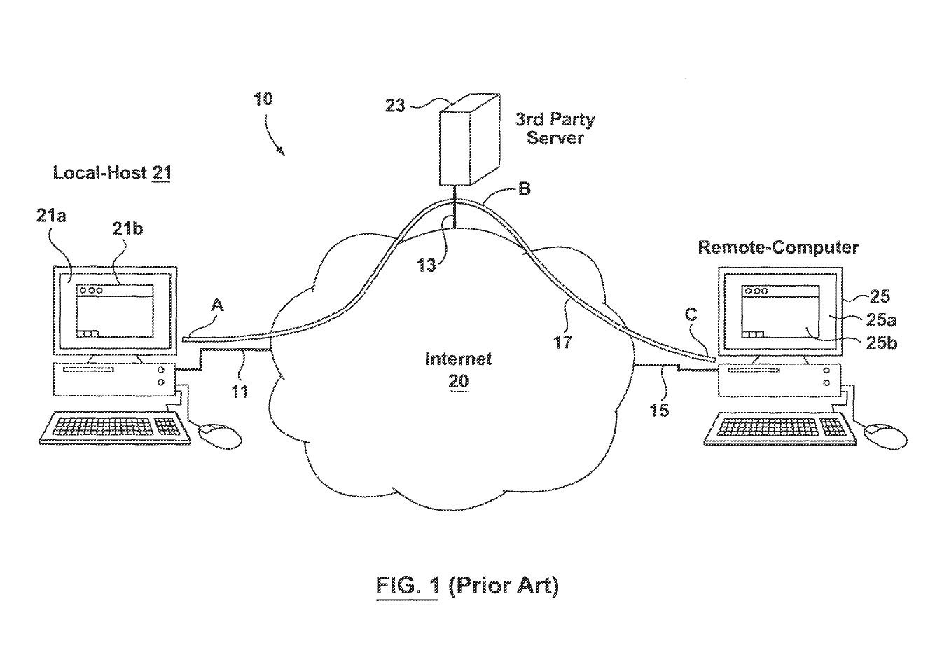

FIG. 1 is a simplified schematic illustration of a typical prior art system 10 for remote-access computing. Those skilled in the art will appreciate that a system may include any suitable combination of hardware, software and firmware required to implement the desired functionality of a particular system, and only those features and elements necessary to describe specific aspects of the system 10 have been included in FIG. 1. Specifically, the system 10 includes a local-host computer 21, remote computer 25 and a third party server 23. The local-host computer 21, the remote computer 25 and third party server 23 have respective network connections 11, 15 and 13 to the internet 20.

In operation, remote-access computing is provided through a data link 17 between the local-host computer 21 (starting at A) and the remote computer 25 (ending at C) that traverses through and is managed by the third party server 23 (at B). A user operating the local-host computer 21 can access data and software on the remote computer 25 that is remotely situated from the local-host computer 21. In accordance with previously available remote-access computing systems and methods, access to data and software on the remote computer 25 from the local-host computer 21 is managed through a subscription-service provided by a third party operating the third party server 23. Typically, the third party provides a browser-based (i.e. internet browser or the like) software application, provided from the server 23, that manages data sharing between the computers 21 and 25.

A browser window 21b on the local-host computer 21 displays the desktop of the remote computer 25a so that the user can manipulate data and software located on the remote computer (shown for example only as window 25b) through the browser window 21b on the local-host computer. That is, the user remotely accesses data and software on the remote computer 25 through a browser window 21b open on the local-host computer 21 while the local-host computer 21 otherwise operates normally—with for example only, the default desktop 21a of the local-host computer displayed behind the window 21b.

There are a number of problems associated with the prior art system 10. First, because the local-host computer 21 is running normally, processes and software applications specific to the local-host computer 21 may contaminate the remote computer 25 with viruses, spyware or other malware. Second, because the systems are browser-based, temporary files, passwords and/or other user-specific information are left on the local-host computer 21 in caches or temp directories that support the browser. Moreover, the files on the remote computer 25 that the user accesses from the local-host computer 21 are edited on the local-host computer 21, which allows them to be either intentionally or inadvertently stored on the local-host computer 21. If the user forgets to delete the files or does not know that the files are being stored on the local-host computer 21 valuable information may be revealed or put in a position where the information could be revealed to those not entitled to view the information.

Third, the local-host computer 21 may be configured to operate in a particular language (e.g. English, French, Chinese, etc.) that is foreign to the user. So while the user may be able to recognize the basic functionality of software applications by the configuration of toolbars and icons, the user may not be able to use more advanced functions to edit and manipulate data retrieved from the remote computer 25. That is, the functionality available to the user may be limited as a result of language barriers that the user may not be able to avoid or know about in advance.

Fourth, because remote-access computing provided by the prior art involves a third party subscription service, the user is forced to entrust the management of data (which is possibly sensitive and/or valuable) to a third party. This presents problems for the third party and the user. The third party may be liable for losses of information transferred through the service or inappropriately and unwillingly disclosed as a result of the security of their server(s) being compromised. The user, regardless of the potential liability of the third party, may nevertheless lose valuable information or have the security of their information compromised.

Fifth, for the prior all systems and methods to work, the remote computer 25 must be on and running normally. This in itself causes security risks. In a remote-access computing scenario the user is not often near the remote computer 25) which in turn leaves open the possibility that someone else may access the remote 25 computer or observe what the user is doing on the remote computer 25 without being detected.

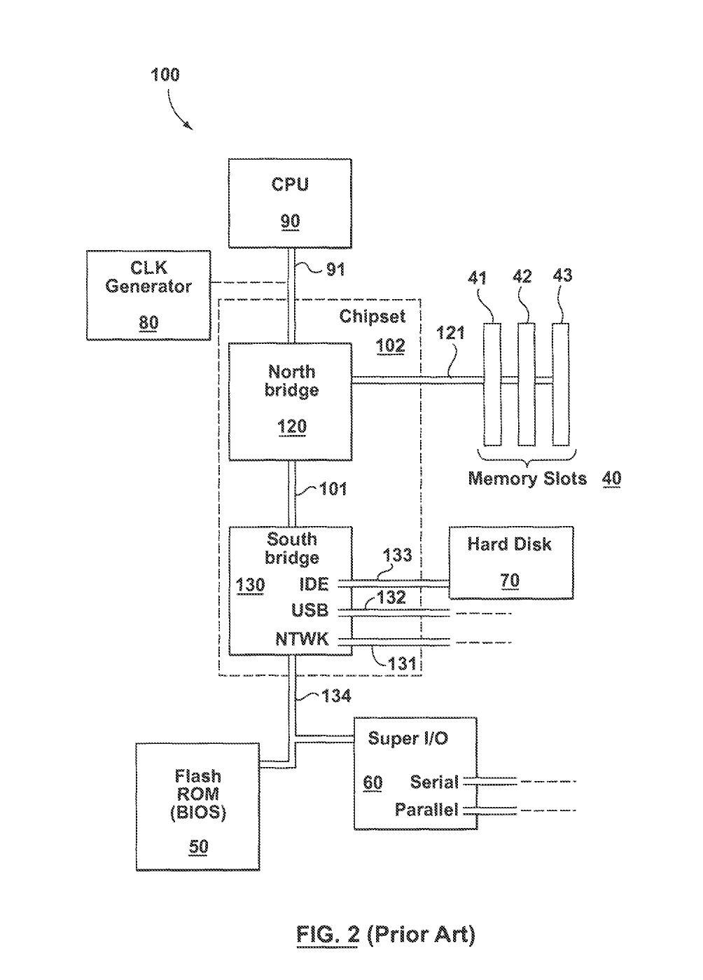

FIG. 2 is a simplified schematic illustration of a motherboard (or mainboard) 100 for a personal computer known in the art. Those skilled in the art will appreciate that a typical motherboard includes a more complex combination of hardware, software and firmware required to implement the desired functionality. However, for the sake of brevity, only those features and elements necessary to describe specific aspects of the motherboard 100—as they relate to aspects of the invention described in further detail below—have been included in FIG. 2. Specifically, the motherboard includes a chipset 102 that includes a northbridge 120 and a southbridge 130. Those skilled in the art will appreciate that in other motherboard configurations the northbridge 120 and the southbridge 130 may be integrated into a single chip. The motherboard 100 also includes a slot for the Central Processing Unit (CPU) 90. The CPU 90 is included in FIG. 2 for simplicity. The motherboard 100 also includes a clock generator 80, memory slots 41, 42 and 43 (indicated generally as memory slots 40), a flash Read Only Memory (ROM) 50 and a Super I/O (input/output) chip 60.

The northbridge 120 is also known in the art as the memory control hub because it is provided to primarily control communications between the CPU 90 and the memory slots 40. The northbridge 120 is connected to the CPU 90 through a front side bus 90 and to the memory slots 40 through a memory bus 121. Those skilled in the art will appreciate that the northbridge 120 may also be connected to a video card (not shown) or other devices from/to which relatively short delays to the CPU are desirable.

The southbridge 130 is also known as the Input/Output (I/O) control hub, and is typically used to implement relatively slower functions on the motherboard 100. The southbridge 130 is typically not directly connected to the CPU 90. Instead the southbridge 130 is indirectly connected to the CPU 90 through the northbridge 120 via an internal bus 101. The internal bus 101 is often custom designed to ensure relatively fast communication between the northbridge 120 and the southbridge 130. Commonly, the southbridge 130 provides connections between the motherboard 100 and other devices, such as but not limited to, a hard disk 70, one or more USB ports and network connections. In FIG. 2, the connections from the Southbridge 130 include an Integrate Device Electronics (IDE) port 133 (e.g. to the hard disk 70 or a CD or DVD drive), a USB port 132 and a network connection port 131. The Southbridge 130 also includes Low Pin Count (LPC) bus 134 that connects the southbridge 130 to the flash ROM 50 and the Super I/O 60.

The problems with the previous systems and methods for remote-access computing can be understood with reference to FIGS. 1 and 2. If the motherboard 100 (shown in FIG. 2) is the motherboard in the local-host computer 21, while a user accesses the remote computer 25 the motherboard 100 operates normally. Specifically, the local-host computer 21 is connected to the remote computer 25 through the data link 17 that traverses the internet 20 through the third party server 23. The connection ultimately enters the motherboard 100 through network connection port 131. However, at the same time, the CPU 90 has continued access to the system memory, which includes without limitation, the memory slots 40 and the hard disk 70. These memory elements are specific to the local-host computer 21. During operation, files from the remote computer 25 may be stored in the memory elements of the local-host computer 21, and/or malware residing in the memory elements of the local-host computer 21 may infect the remote computer 25 by passing through the network connection port 131 and into the data link 17. Moreover, in order to maintain the data link 17 and the browser-based remote-access application provided by the third party, the local-host 21 is forced to operate normally given the inherent need to access the local memory elements required for nominal operation.

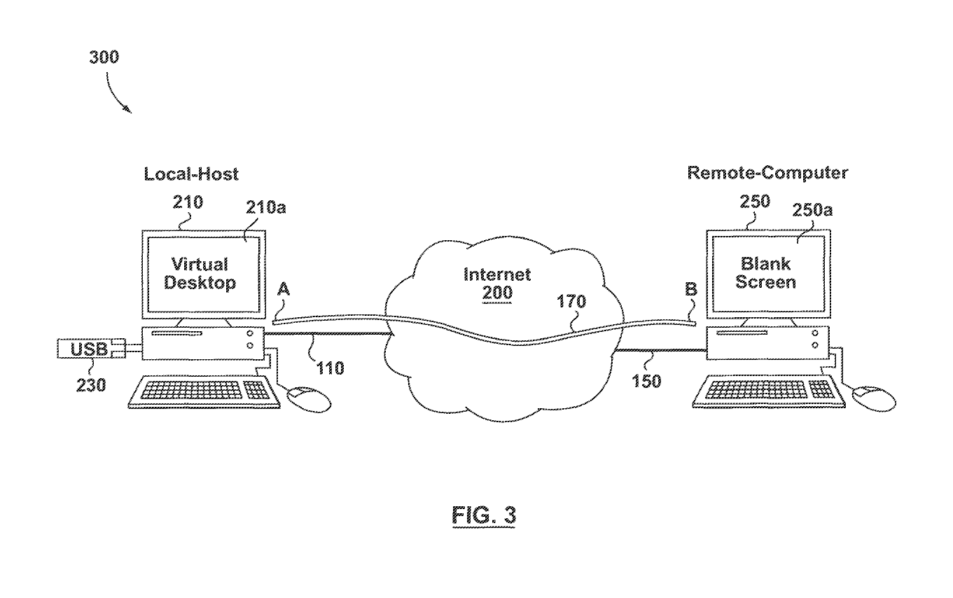

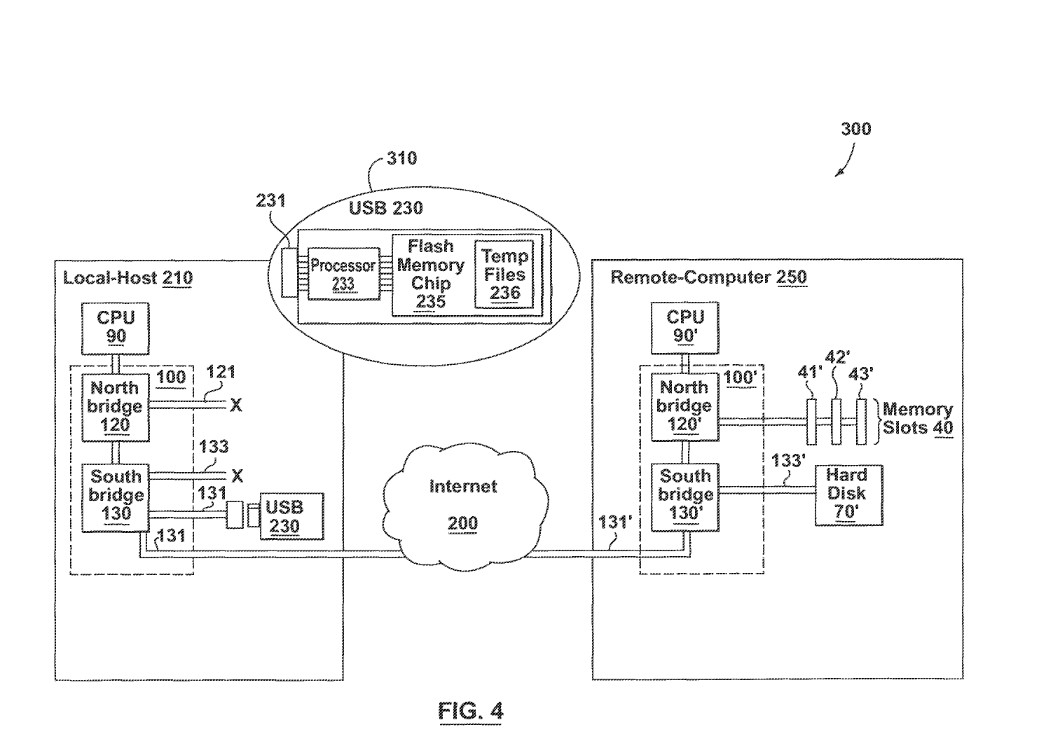

In contrast, provided by aspects of the present invention are systems, methods and devices for secure remote-access computing that enable more secure remote-access computing and may enhance predictability of performance from the perspective of the user. As an illustrative example only, FIGS. 3 and 4 show a simplified schematic illustrations of a secure remote-access computing system 300 and device 230 (in this specific embodiment the device is a USB flash drive) provided in accordance with specific aspects of the invention. Those skilled in the art will appreciate that a system and a device may include any suitable combination of hardware, software and firmware required to implement the desired functionality of a particular system, and only those features and elements necessary to describe specific aspects of the system 300 the device 230 have been included in FIGS. 3 and 4.

With specific reference to FIG. 3, the system 300 includes a local-host computer 210, remote computer 250 and a USB flash drive 230. The USB flash drive is configured and programmed in accordance with aspects of the invention. The local-host computer 210, the remote computer 250 have respective network connections 110, 150 to the internet 200.

In operation, remote-access computing is provided through a data link 170 between the local-host computer 210 (starting at A) and the remote computer 250 (ending at B) that traverses through the internet 200, but is not directly managed by a third party. A user operating the local-host computer 210 can access data and software on the remote computer 250 that is remotely situated from the local-host computer 210. In accordance with aspects of the present invention, a user can access data and software on the remote computer 250 from the local-host computer 210.

However, unlike the prior art, remote-access computing in accordance with aspects of the present invention re-configures and co-ordinates the operations of the local-host computer 210 and the remote computer 250 so that the two computers in effect operate as a single unit in which temporary files, passwords, java cookies and the like are stored on the USB flash drive 230.

Turning to FIG. 4, the USB flash drive 230 provided in accordance with aspects of the invention is shown in window 310. Those skilled in the art will appreciate that a USB flash drive normally includes a suitable combination of hardware, software and firmware required to implement the desired functionality, but only those features and elements necessary to describe specific aspects of the invention have been included in FIG. 4. Specifically, the USB flash drive 230 includes a USB connector 231, a micro-processor (controller) 233 and a flash memory chip 235. The flash memory chip 235 is the repository for temporary files, passwords, java cookies and the like that are retrieved from the remote computer 250 while the user operates the local-host computer. To clarify, the USB flash drive 230 operates when connected to the USB port 131 of the local-host 210.

Additionally, in use, without limitation to the scope of the following claims, the USB flash drive 230 is preferably owned and/or is under the control of a specific user, since the specific user is using the flash drive to access their own secure information or secure information the user is entitled to access, use, etc. That is, one specific use of the USB flash drive 230 provided in accordance with aspects of the invention is to enable a specific user to remotely access a home computer (or the like) from a local host—which is, for example, in the business center of a hotel.

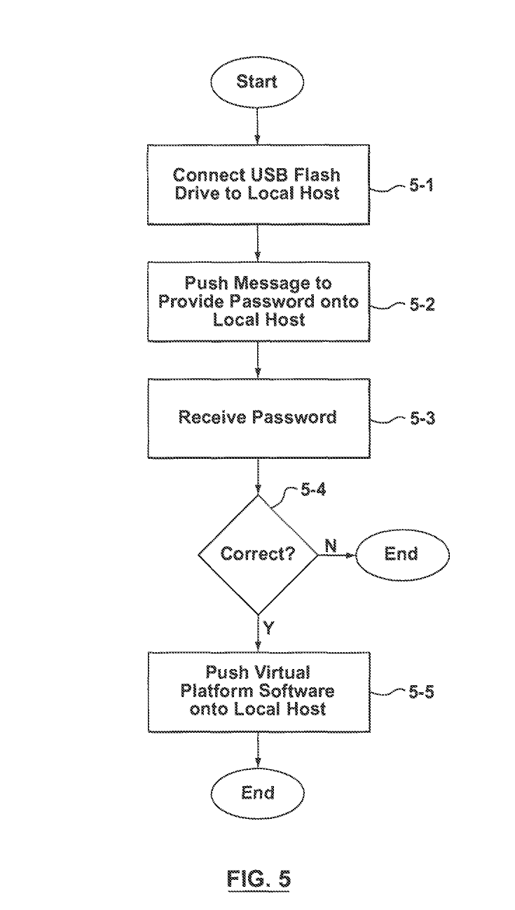

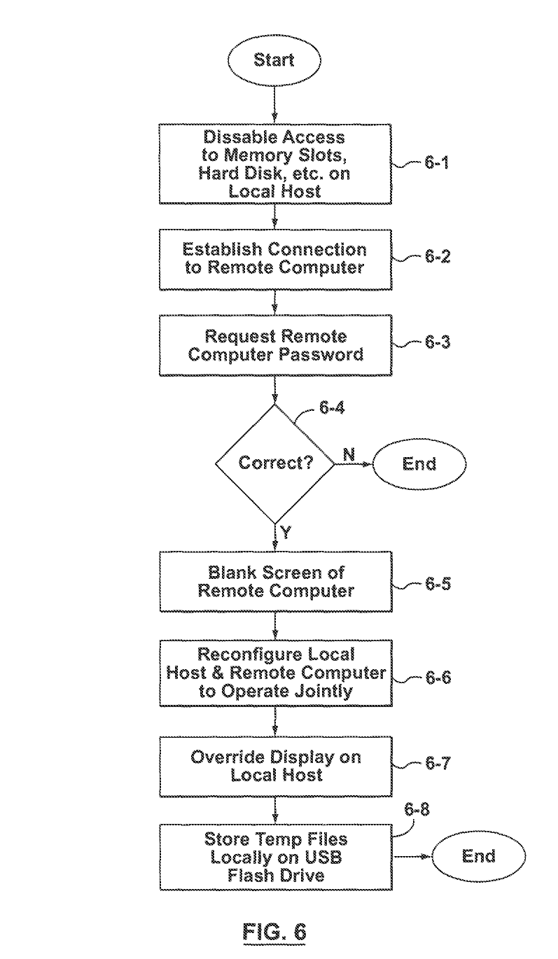

The USB 230 also stores computer program code having instructions for re-configuring the local-host computer 210 to operate jointly with the remote computer 250. The computer program code also has instructions for establishing a connection to the remote computer 250 through the network connection port 131 and the internet 210, and re-configuring the remote computer 250 to operate jointly with the local-host computer 210. Specific aspects of the compute program code instructions stored on the USB flash drive 230 are described below with reference to the flow charts shown in FIGS. 5 and 6.

Before turning to FIGS. 5 and 6, the effects of the computer program code instructions provided in accordance with aspects of the invention and stored on the USB flash drive 230 can be understood with further reference to FIGS. 3 and 4. Specifically, FIG. 4 also shows a simplified schematic illustration of the motherboards within local-host computer 210 and remote computer 250, which have been re-configured to operate jointly in accordance with aspects of the invention. In the local-host computer 210 the effects of running the computer program code instructions stored on the USB flash drive 230 include disabling access to the memory elements (e.g. the memory slots 40 and the hard disk 70 shown in FIG. 2) within the local-host computer 210.

Specifically, the northbridge 120 is receives instructions to temporarily disable communication through the memory bus 121. Likewise, the southbridge 130 receives instructions to disable communication through the IDE port 133 so that the hard disk 70 of the local-host computer 210 is effectively excluded from the operation of the remote-access computing session. The local-host computer 210 is further operated so that the desktop 210a displayed is that of the remote-computer 250. This is unlike the prior art, in which the desktop of the remote computer is displayed within a window that is displayed on the normal desktop of the lock-host computer 210. Accordingly, while the user is using the local-host computer 210 to access the remote computer 250 in accordance with aspects of the invention, data and software residing in the memory elements of the local-host computer 210 cannot be accessed or initiated, thereby reducing the chance that malware on the local-host computer 210 will infect the remote-computer. Moreover, all temporary files, password, java cookies and the like are stored on the flash memory chip 235 of the USB flash drive 230. That is, in the re-configured state in accordance with aspects of the invention, the flash memory chip 235 serves as the only substantial mass storage memory element locally available to the local-host computer 210.

The remote computer 250 is also re-configured in accordance with aspects of the invention. First, display of the remote computer 250 blanked either by temporarily disabling the video card or by another suitable means so that information on the remote computer 250 cannot be seen while the remote computer 250 is being remotely accessed in accordance with aspects of the invention Second, the northbridge 120′ and the southbridge 130′ are provided with instructions to permit the local-host computer 210 to remotely access the system memory of the remote computer 250 and so that instructions from the CPU 90 and the CPU 90′ do not conflict.

For further clarification, aspects of the aforementioned description of the operation of the secure remote-access computing system, method and device according to aspects of the invention are depicted in the flow charts provided in FIGS. 5 and 6. Specifically, FIG. 5 is a flow chart illustrating general method steps for initiating a secure remote-access computing session in accordance with aspects of the invention. Staring at step 5-1, the method includes connecting a USB flash drive, that has been configured and preprogrammed in accordance with aspects of the invention, to a local-host computer. Step 5-2 includes pushing a message from the USB flash drive onto the local-host prompting the user to enter a password. According to some aspects the password is created in advance by the user, so that only the user can access the information on the USB flash drive and have the option to connect to a specific remote computer. This is optionally the first level of security provided for remote-access to information and the information stored on the USB flash drive. According to further aspects of the invention, the USB flash drive is programmed such that if the user password is forgotten there is no way to reset or retrieve the password on the USB flash drive. Consequently, all information on the USB flash drive would be lost in the sense that it could not be retrieved from the USB flash drive. However, it also means that others not entitled to view the information or connect to a specific remote computer cannot retrieve the information on the USB flash drive or connect to the specific remote computer. Additionally and/or alternatively, in other embodiments, the password may be reset only when the USB flash drive is connected to the specific remote computer that belongs to the user or to which the user has at least some administrative control over.

At step 5-3, the method includes receiving a password from the user (or another), Step 5-4 includes determining whether or not the password received from the user (or another) is correct. If the password is not correct (no path, step 5-4), then the method ends. In such circumstances, the user (or another) would have to disconnect the USB flash drive from the local-host and then reconnect it to try to enter a new password. Additionally and/or alternatively, in other embodiments, the method may loop back to step 5-2 a number of times to allow the user (or another) to attempt to re-enter the correct password. If the password is correct (yes path, step 5-4), the method moves to step 5-5 which includes pushing the virtual platform software implementing the remainder of the secure remote-access method onto the local-host computer. The virtual platform software then operates to re-configure, connect and operate the two motherboards of the local-host computer and the remote computer jointly.

FIG. 6 is a flow chart illustrating general method steps for re-configuring, connecting and operating two motherboards to operate jointly in order to provide a secure remote-access computing session in accordance with aspects of the invention. Starting at step 6-1, the method includes temporarily disabling access to the system memory of the local-host computer, which includes without limitation, access to the memory slots connected to the memory bus and the hard disk which may be connected to the Southbridge of the motherboard within the local-host computer.

At step 6-2, the method includes establishing a connection to the remote computer. In specific circumstances, the user will select a specific remote computer to access remotely from the local-host computer. At step 6-3, the method optionally includes requesting the user to enter a remote computer password. The remote computer password is separately processed from the password used to access the USB flash drive. In the first instance, the password required to access the USB flash drive discussed above is preferably verified through the operation of the microprocessor included on the USB flash drive as an initial step in a specific implementation of a secure remote-access computing method in accordance with aspects of the invention. At this stage, the remote computer password is preferably verified on the specific remote computer selected by the user. To that end, step 6-4 of the method includes verifying whether or not the remote computer password provided by the user (or another) is correct. If the remote computer password is not correct (no path, step 6-4), then the method ends. In such circumstances, the method may loop back to step 6-3 a number of times to allow the user (or another) to attempt to re-enter the correct password. If the remote computer password is correct (yes path, step 6-4), the method moves to step 6-5.

At step 6-5, the method includes blanking the screen of the remote computer so that unauthorized persons may not view the data and/or software accessed on the remote computer by the user operating the local-host computer. Step 6-6 of the method includes further re-configuring both the local-host computer and the remote computer as de scribed above so that the two computers can operate jointly. Step 6-7 of the method includes overriding the display of the local-host computer so that the local-host computer displays the desktop of the remote computer. And in nominal operation, step 6-8 of the method includes storing temporary files, passwords, java cookies and the like on the USB flash drive so that traces of the remote-access computing session are not saved or otherwise left on the local-host computer.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above disclosure.

1. A device for establishing a connection between a first and second computer the device comprising:
a connector suitable for connecting the device to the first computer;
a flash memory chip for storing electronic data and computer program instructions;
virtual platform software provided in a computer program product having computer program instructions for re-configuring, connecting and operating the first and second computers to operate jointly in order to provide secure remote access computing; and
a controller coupled between the controller and the and flash memory chip, the controller capable of executing computer program instructions.

2. A device according to claim 1, wherein the connector is a Universal Serial Bus (USB) connector.

3. A device according to claim 1 wherein the computer program product includes computer program code instructions for:
pushing a message from the device to be displayed on the first computer, the message requesting a password to access the device;
receiving a password from the user, and
verifying whether or not the password received from the user is correct, and if the password from the user is not correct denying the user access to the device, but if the password from the user is correct permitting the user to access the device.

4. A device according to claim 1, wherein the computer program product includes instructions for pushing the virtual platform software onto the local host from the device.

5. A device according to claim 1 wherein the virtual platform software includes computer program instructions for:
disabling memory access to the local system memory on the first computer;
establishing a network connection between the first and second computers by controlling a network port on the first computer;
blanking the screen of the second computer;
re-configuring the first and second computers to operate jointly using a network connection between them;
overriding the display on the first computer to display the desktop of the second computer and
storing temporary files in the flash memory chip of the device instead of local system memory of the first computer.

6. A device according to claim 5, wherein the virtual platform software includes computer program instructions for providing the second computer with a computer program product for verifying user access to the second computer.

7. A device according to claim 6, wherein the computer program product for verifying user access to the second computer includes computer program instructions for:
pushing a message from the second computer to be displayed on the first computer, the message requesting a password to access the second computer;
receiving a password from the user; and
verifying whether or not the password received from the user is correct, and if the password from the user is not correct denying the user access to the second computer, but if the password from the user is correct permitting the user to access the second computer.

8. A device according to claim 5, wherein blanking the screen of the second computer includes one of controlling and disabling a video card within the second computer.

9. A device according to claim 5, wherein overriding the screen of the first computer includes one of controlling a video card within the first computer.

10. A device according to claim 5, wherein re-configuring the first and second computers to operate jointly using a network connection between them includes controlling the operation of respective motherboards of the first and second computers.

11. A method for establishing a connection between a first and second computer, the method comprising:
pushing a message from a device to be displayed on the first computer, the message requesting a first password to access the device;
receiving a password from the user; and
verifying whether or not the password received from the user is correct, and if the password from the user is not correct denying the user access to the device, but if the password from the user is correct permitting the user to access the device.

12. A method according to claim 11 further comprising steps for:
disabling memory access to the local system memory on the first computer;
establishing a network connection between the first and second computers by controlling a network port on the first computer;
blanking the screen of the second computer;
reconfiguring the first and second computers to operate jointly using a network connection between them;
overriding the display on the first computer to display the desktop of the second computer; and
storing temporary files in the flash memory chip of the device instead of local system memory of the first computer.

13. A method according to claim 11 further comprising steps for:
pushing a message from the second computer to be displayed on the first computer, the message requesting a second password to access the second computer;
receiving a password from the user; and
verifying whether or not the password received from the user is correct, and if the password from the user is not correct denying the user access to the second computer, but if the password from the user is correct permitting the user to access the second computer.

14. A method according to claim 12, wherein blanking the screen of the second computer includes one of controlling and disabling a video card within the second computer.

15. A method according to claim 12, wherein overriding the screen of the first computer includes one of controlling a video card within the first computer.

16. A method according to claim 12, wherein re-configuring the first and second computers to operate jointly using a network connection between them includes controlling the operation of respective motherboards of the first and second computers.

17. A system for establishing a connection between a first and second computer, the system comprising a device having a connector suitable for connecting the device to the first computer, and a computer program instructions for re-configuring, connecting and operating the first and second computers to operate jointly in order to provide secure remote-access computing.

18. A system according to claim 17, wherein the device further comprises:
a flash memory chip for storing electronic data and computer program instructions;
virtual platform software provided in a computer program product having computer program instructions for re-configuring, connecting and operating the first and second computers to operate jointly in order to provide secure remote-access computing; and
a controller coupled between the controller and the and flash memory chip, the controller capable of executing computer program instructions.

19. A system according to claim 18, wherein the connector is a Universal Serial Bus (USB) connector.

20. A system according to claim 18, wherein the computer program product includes computer program code instructions for:
pushing a message from the device to be displayed on the first computer, the message requesting a password to access the device;
receiving a password from the user; and
verifying whether or not the password received from the user is correct, and if the password from the user is not correct denying the user access to the devices but if the password from the user is correct permitting the user to access the device.
